(19) United States
(12) Patent Application Publication
(10) Pub. No.: US 2009/0288016 A1
(43) Pub. Date: Nov. 19, 2009

(54) METHOD AND SYSTEM FOR TRANSFERRING FULL-TRACK CONTENT MEDIA FILES FROM A SERVER COMPUTER SYSTEM TO A USER MOBILE DEVICE

(75) Inventors: Joseph M. Bilman, Brooklyn, NY (US); Paula Buzzard, Brooklyn, NY (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: Thumbplay, Inc., New York, NY (US)

(21) Appl. No.: 12/121,697

(22) Filed: May 15, 2008

(51) Int. Cl. G06F 3/01

(52) U.S. Cl. 715/748

(57) ABSTRACT

The invention provides a method of transferring media, comprising receiving a selection from a user computer system over a network at a server computer system, transmitting a download page from the server computer system to the user computer system, the download page having a link, based on the selection, a full-track content media file being downloadable from the server computer system onto the user computer system when selecting the link, determining at the server computer system whether a mobile device can receive full-track content, and transmitting the full-track content media file from the server computer system to the mobile device in response to the selection, only if the mobile device can receive full-track content.

### BACKGROUND OF THE INVENTION

1). Field of the Invention

This invention relates to a computer-based method and system for manipulating electronic media such as full-trade content, ringtones and videos.

2). Discussion of Related Art

Mobile phones usually have a number of ringtones that are installed by a manufacturer. A user can select a ringtone from a drop-down list, and it is also sometimes possible to associate different ringtones with different incoming phone numbers.

A user may wish to download a ringtone from a remote server and store the ringtone in memory of the mobile phone. However, a mobile phone and the network that it is connected to are usually too slow and the viewing capabilities on the mobile phone are too limited for finding media on a remote server. A company that provides mobile media content for use on mobile phones will usually also have a website that is accessible from a user computer system over the Internet. The user of the mobile phone may make use of the user computer system to find listings of mobile content on the website through browsing or searching functionality built into the website, and then instruct the website to facilitate downloading of the media content to the mobile phone. A message may, for example, be sent to the mobile phone, and the message can include a link to the media content on the server.

A mobile phone usually also has a player application that can play full-trade media content such as Moving Picture Audio Group (MPEG)-1 Audio Layer 3 (MP3) files. Full-track media content can often not be supported for download from a remote server because not all carriers and types of user mobile devices support transmission of full-track media content, and there is often not a data plan that can be used for transmission of full-track media content.

### SUMMARY OF THE INVENTION

The invention provides a method of transferring media, comprising receiving a selection from a user computer system over a network at a server computer system, transmitting a download page from the server computer system to the user computer system, the download page having a link, based on the selection, a full-track content media file being downloadable from the server computer system onto the user computer system when selecting the link, determining at the server computer system whether a mobile device can receive full-track content, and transmitting the full-track content media file from the server computer system to the mobile device in response to the selection, only if the mobile device can receive full-track content.

The method may further include determining at the server computer system whether a carrier of the mobile device supports full-track content, as part of a process to determine whether the mobile device can receive full-track content.

The method may further include determining at the server computer system whether a type of the mobile device supports full-track content, as part of a process to determine whether the mobile device can receive full-track content.

The method may further include determining at the server computer system whether a data plan is associated with the mobile device, as part of the process to determine whether the mobile device can receive full-track content.

The method may include transmitting a data plan override page from the server computer system to the user computer system if a data plan is not associated with the mobile device, receiving a data plan override selection from the user computer system after a user makes a selection on the data plan override page, and transmitting the full-track content media file from the server computer system to the user computer system, only if the data plan override selection indicates that the full-track content media file should be transmitted and not when the data plan override selection indicates that the full-track content media file should not be transmitted.

The invention also provides a method of transferring media, including transmitting an options page from a server computer system to a user computer system, the options page including a full-track link and a reduced-track link, selection of the reduced-track link facilitating transmission of a reduced media file corresponding to a time portion only of a full-track content media file, from the server computer system to a user mobile device, receiving a selection from the user computer system after the user selects the full-track link, determining at the server computer system whether a mobile device can receive full-track content, and transmitting the full-track content media file from the server computer system to the mobile device in response to the selection, only if the mobile device can receive full-track content.

The invention further provides a computer-readable medium having stored thereon a set of instructions which, when executed by a processor of at least one computer system, executes a method of transferring media, including receiving a selection from a user computer system over a network at a server computer system, transmitting a download page from the server computer system to the user computer system, the download page having a link, based on the selection, a full-track content media file being downloadable from the server computer system onto the user computer system when selecting the link, determining at the server computer system whether a mobile device can receive full-track content, and transmitting the full-track content media file from the server computer system to the mobile device in response to the selection, only if the mobile device can receive full-track content.

The invention further provides a computer-readable medium having stored thereon a set of instructions which, when executed by a processor of at least one computer system, executes a method of transferring media, including transmitting an options page from a server computer system to a user computer system, the options page including a full-track link and a reduced-track link, selection of the reduced-track link facilitating transmission of a reduced media file corresponding to a time portion only of a full-track content media file from the server computer system to a user mobile device, receiving a selection from the user computer system after the user selects the full-track link, determining at the server computer system whether a mobile device can receive full-track content, and transmitting the full-track content media file from the server computer system to the mobile device in response to the selection, only if the mobile device can receive full-track content.

The invention further provides a server computer system, including a file server, a database, having entries corresponding to files in the file server, a memory, holding a set of instructions, and a processor that executes the instructions, the instructions including receiving a selection from a user computer system over a network at a server computer system, transmitting a download page from the server computer system to the user computer system, the download page having a link, based on the selection, a full-track content media file being downloadable from the server computer system onto the user computer system when selecting the link, determining at the server computer system whether a mobile device can receive full-track content, and transmitting the full-track content media file from the server computer system to the mobile device in response to the selection, only if the mobile device can receive full-track content.

The invention further provides a server computer system, including a file server, a database, having entries corresponding to files in the file server, a memory, holding a set of instructions, and a processor that executes the instructions, the instructions including transmitting an options page from a server computer system to a user computer system, the options page including a full-track link and a reduced-track link, selection of the reduced-track link facilitating transmission of a reduced media file corresponding to a time portion only of a full-track content media file from the server computer system to a user mobile device, receiving a selection from the user computer system after the user selects the full-track link, determining at the server computer system whether a mobile device can receive full-track content, and transmitting the full-track content media file from the server computer system to the mobile device in response to the selection, only if the mobile device can receive full-track content.

### BRIEF DESCRIPTION OF THE DRAWINGS

The invention is further described by way of example with reference to the accompanying drawings, wherein:

FIG. 1 is a block diagram of a network system in which aspects of the invention are manifested;

FIG. 2 is a screenshot of a browser view that displays a view of a website;

FIG. 3 is a view similar to FIG. 1, after a search has been conducted for media files in a database in FIG. 1;

FIG. 4 is a view similar to FIG. 3, wherein registration and login information are completed and an instruction is sent to a server computer system to transmit a media file to a user mobile device;

FIG. 5 is a block diagram illustrating integration of full-track media content for transmission to a user mobile device;

FIGS. 6 to 10 are views that are displayed at a user computer system during the process shown in FIG. 5;

FIG. 11 is a view of a user-specific page that is displayed at the user computer system;

FIG. 12 is a view similar to FIG. 11, after a button is selected to download a file onto the user computer system; and

FIG. 13 is a block diagram of a machine in the form of a computer system that may find application in the network system of FIG. 1.

### DETAILED DESCRIPTION OF THE INVENTION

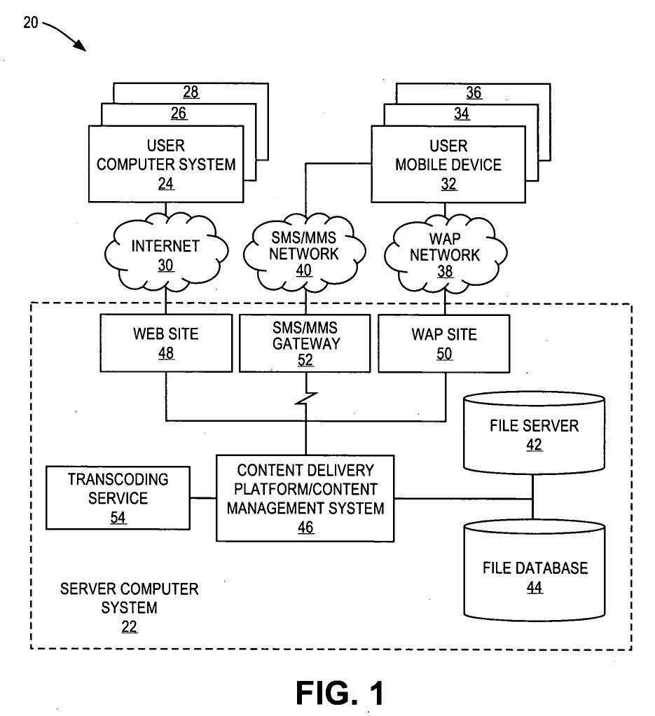

FIG. 1 of the accompanying drawings illustrates a network system 20 that embodies features of the invention. The network system 20 includes a server computer system 22, a plurality of user computer systems 24, 26, and 28 that are connected to the server computer system 22 over a network in the form of the Internet 30, and a plurality of user mobile devices 32, 34, and 36 that are connected over a Wide Application Protocol (WAP) network 38 and over a Short Message Service (SMS) and Multimedia Messaging Service (MMS) network 40 to the server computer system 22.

The server computer system 22 includes a file server 42, a file database 44, a content delivery platform and content management system 46, a Web site 48, a WAP site 50, an SMS/MMS gateway 52, and a transcoding service 54. The file database 44 is connected to the file server 42. The content delivery platform and content management system 46 forms the center of the server computer system 22, and all other components including the Web site 48, WAP site 50, SMS/MMS gateway 52, transcoding service 54, file server 42, and file database 44 are directly connected to the content delivery platform and content management system 46. The content delivery platform and content management system 46 indexes files such as ringtones (reduced media content), full-track content, games, wallpaper, and graphics from the file server 42 into the file database 44 and in a structured manner, as will be required for downloading and for the Web site 48, WAP 50, SMS/MMS gateway 52, and transcoding service 54. The transcoding service 54 prepares communications suitable for transmission over the Internet 30, WAP network 38, and SMS/MMS network 40.

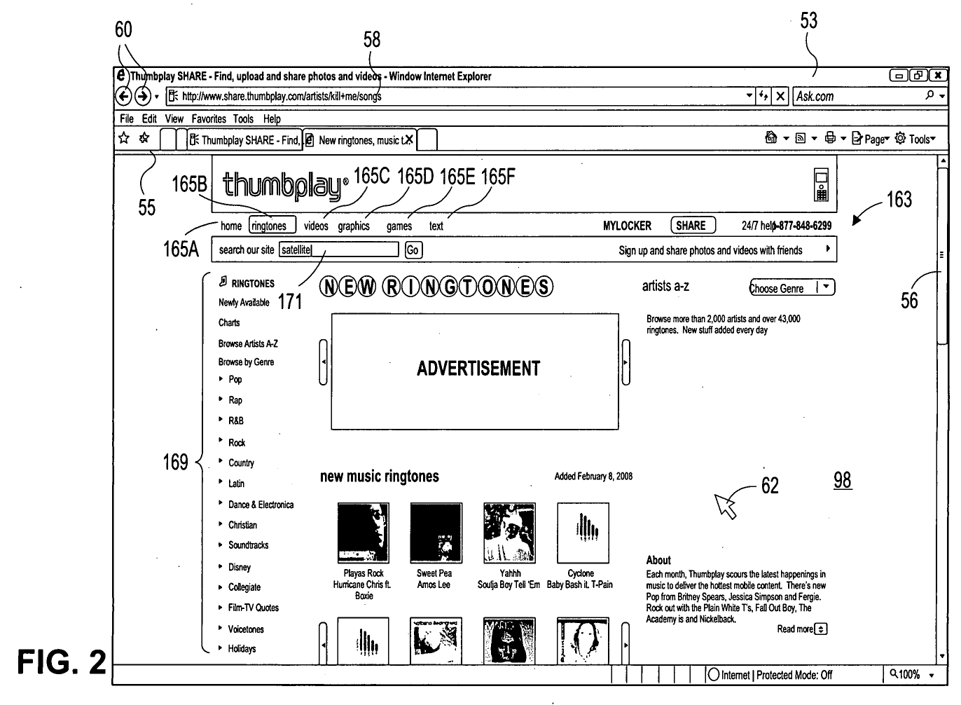

FIG. 2 illustrates a home page 163 within a browser view 53 at the user computer system 24, 26, or 28 in FIG. 1. The browser view 53 forms part of an Internet browser application such as Internet Explorer®, Netscape®, or Firefox®. The browser view 53 includes a viewing pane 55 within which the home page 163 is displayed. The browser 53 also includes a vertical scroll bar 56 that can be moved up or down to view portions of the home page 163 if the entire home page 163 does not fit vertically within the viewing pane 55. The browser 53 also has an address box 58 and back and forward buttons 60. A user can use a mouse to move a cursor 62 into the address box 58, and then depress a button on the mouse to select the address box 58. The user can then utilize a keyboard to enter text such as “http://www.thumbplay.com” in the address box 58, and can then depress an “enter” key on the keyboard to transmit a signal and a request for a page. The text within the address box 58 can also be automatically updated, for example when a user logs into the home page 163. The back and forward buttons 60 can be used to view earlier or subsequent pages.

The home page 163 is in a general area of the Web site 48 in FIG. 1. The home page 163 includes tabs 165A to 165F that provide links to other pages of the general area. In the home page 163, the tab 165B is highlighted, indicating that the home page 163 is in a portion of the general area relating to ringtones.

The home page 163 is typically displayed at one of the user computer systems 24, 26, or 28 in FIG. 1, and provides the user computer systems 24, 26, or 28 access to ringtones through a browse menu 169 or by entering text in a search box 171. Text can, for example, be entered in the search box 171, and an acquiring user can then either select a “go” button 172 or hit “enter” on a keyboard to cause transmission of a signal from the user computer systems 24, 26, or 28 over the internet 30 to the Web site 48. The signal includes an address for the Web site 48, a query that is entered in the search box 171, and a return address for the user computer systems 24, 26, or 28. The query is used at the Web site 48 to extract one or more search results. A signal is then transmitted from the Web site 48 over the internet 30 to the user computer systems 24, 26, or 28, the signal including the search result or search results and an address corresponding to the return address received from the user computer 24, 26, or 28.

Not every signal is described in detail herein. One skilled in the art will appreciate that a signal is generated by and transmitted from one computer system and received and processed at another computer system, and will also appreciate what the contents of such a signal will be. One skilled in the art will also appreciate that a computerized step is typically carried out by a respective module of software code stored in memory of a computer. For example, a transmission step is typically carried out by a transmission module, a receiving step is carried out by a receiving module, a password generation step is carried out by a password generation module, etc. These modules are connected to one another so that a step carried out by one module can be followed by a step carried out by another module.

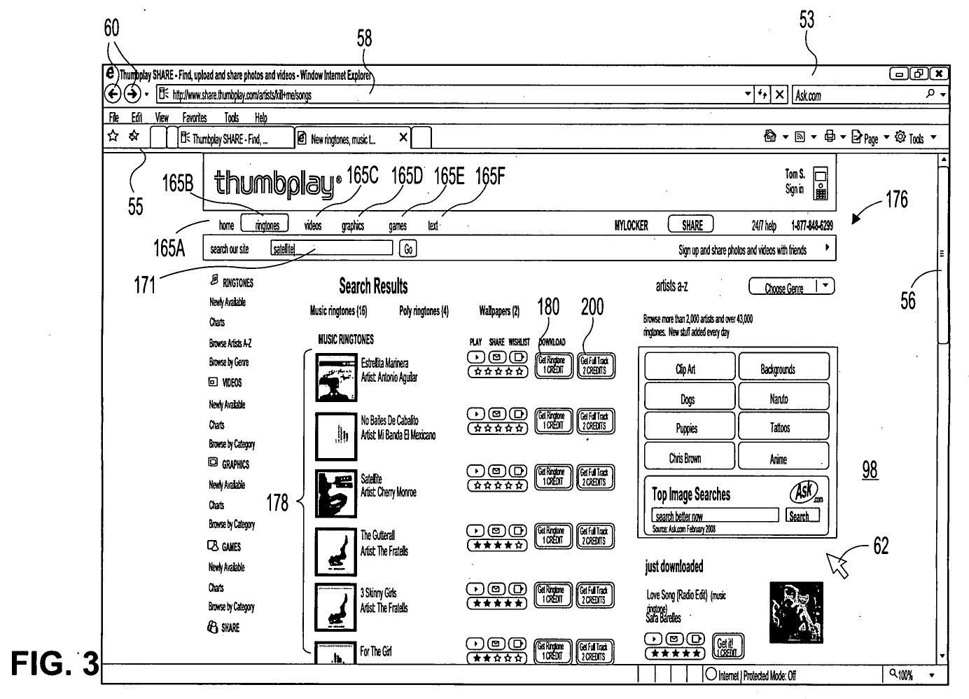

FIG. 3 shows a view 176 that includes a download page with a plurality of search results 178 that are received at the user computer systems 24, 26, or 28 over the Internet 30 from the Web site 48. Each search result 178 includes a ringtone name, an artist name, and a ringtone download button 180, among other things.

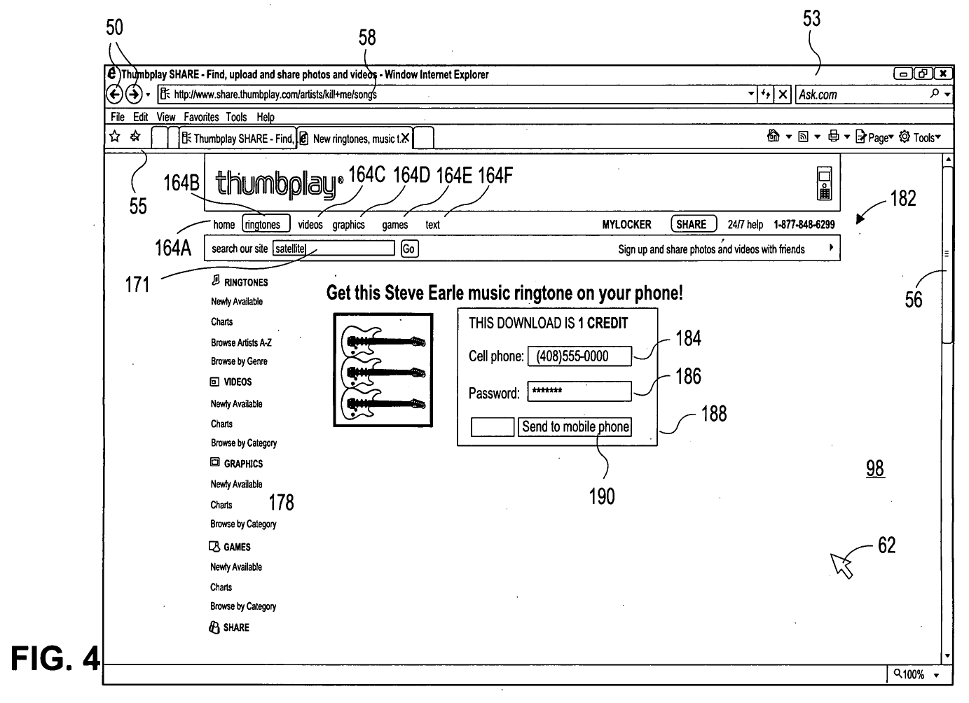

FIG. 4 shows a view 182 that is displayed upon selection of one of the ringtone download buttons 180 in the view 176 of FIG. 3. A profile of the acquiring user computer system 24 is previously stored on the content delivery platform and content management system 46 of FIG. 1, including a mobile phone number 184 and a password 186. The view 182 includes the mobile phone number 184 and a password text box 188 for entering the password 186. The view 182 also has a “transmission” button 190. Upon selection of the “transmission” button 190, a signal is sent from the user computer system 24 over the Internet 30 to the Web site 48. The Web site 48 communicates with the content delivery platform and content management system 46, which uses the selected search result to access one of the ringtones on the media file server 42. The content delivery platform and content management system 46 then transmits a link corresponding to the accessed ringtone on the media file server 42 over the SMS/MMS network 40 to a user mobile device 32, 34, or 36 having the mobile phone number 184 in the view 182 of FIG. 4.

The link that is received at the user mobile device 32, 34, or 36 comes in the form of a simple SMS message that includes the link. An acquiring user can utilize “arrow” and “enter” keys of the user mobile device 32, 34, or 36 to select the link. Upon selection of the link, the user mobile device 32, 34, or 36 transmits a requesting signal over the WAP network 38 to the content delivery platform and content management system 46, which then automatically transmits a copy of the selected ringtone from the media file server 42 over the WAP network 38 to the respective user mobile device 32, 34, or 36. The respective user mobile device 32, 34, or 36 then automatically stores the copy of the selected ringtone in memory.

FIG. 3 shows that selected ones of the search results 178 each include a respective full-track download button 200 in addition to a respective ringtone download button 180. Ringtones and corresponding full-track content files are stored in the file server 42 in FIG. 1. A full-track content file can be played on a player from a start time to an end time over a first period of time. A ringtone is a reduced media file corresponding to a section only of the full-track media file. The ringtone plays from a start time which is typically after the start time of the full-track media file to an end time which typically is before the end time of the full-track media file, over a shorter period of time than the full-track media file. A full-track media file may, for example, be three or four minutes long, whereas the ringtone may only be between 20 and 30 seconds long. Further details of full-track media files and ringtones are described in U.S. patent application Ser. No. 12/051,781 filed on Mar. 19, 2008, which is incorporated herein by reference.

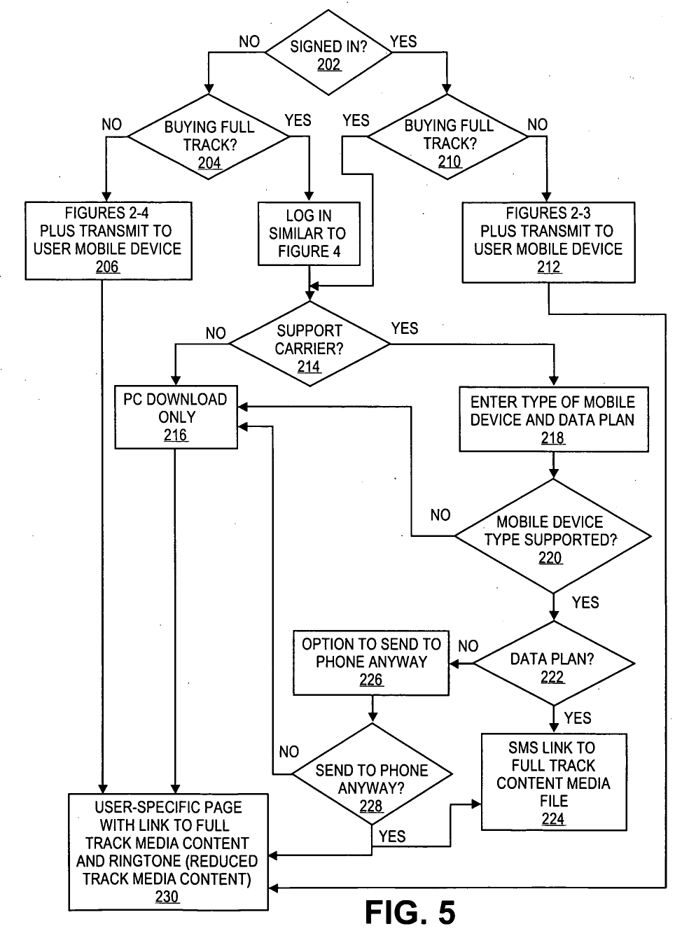

FIG. 5 illustrates a process that is primarily carried out at the server computer system 22 in FIG. 1, for determining whether full-track content can be transmitted to a respective user mobile device 32, 24, or 36 in FIG. 1. At Step 202, the server computer system 22 determines whether a respective user computer system, e.g., the user computer system 24 in FIG. 1, is signed in. A hard sign-in process may, for example, have occurred wherein a user has entered a user name and password. Alternatively, a soft sign-in process may have occurred, wherein a “cookie” may have been utilized. Cookies are parcels of text sent by a server to a web browser and then sent back unchanged by the browser each time it accesses that server in FIG. 1. Hypertext Transfer Protocol (HTTP) cookies are used for authenticating, tracking, and maintaining specific information about users that has been transmitted from the user computer system 24 to the server computer system 22. If no sign-in has occurred, the server computer system 22 determines whether a purchase is being made for a full-track content at Step 204. In FIG. 3, the user has selected either a ringtone download button 180 or a full-track download button 200. If the user has selected a ringtone download button 180, the user computer system 24 sends the selection to the server computer system 22. The server computer system 22 determines that full-track content is not being purchased, and then carries out Step 206, as hereinbefore described with reference to FIGS. 2 to 4. If, at Step 204, the server computer system 22 determines that full-track content is being purchased because the user has selected one of the full-track download buttons 200 in FIG. 3, Step 208 is carried out. Step 208 is similar to the registration process hereinbefore described with reference to FIG. 4. Following completion of Step 208, the user computer system 24 is signed in at the server computer system 22.

If, at Step 202, the server computer system 22 determines that the user computer system 24 is signed in, the server computer system 22 carries out Step 210. At Step 210, the server computer system 22 determines whether full-track content is being purchased, similar to Step 204. If full-track content is not being purchased at Step 210, Step 212 is carried out. Step 212 is similar to the process as hereinbefore described with reference to FIGS. 2 to 3, and a reduced track media file is transmitted to a user mobile device, e.g., the user mobile device 32 in FIG. 1, without a log-in or registration process as described with reference to FIG. 4. If, at Step 210, the server computer system 22 determines that full-track content is being purchased, the server computer system 22 proceeds to Step 214. Because the determination is already made at Step 202 that the respective user computer system 24 is signed in, the log-in process 208 is not carried out after Step 210.

At Step 214, the server computer system 22 determines whether a particular carrier corresponding to the user mobile device 32 supports downloading of full-track content. The phone number of the user mobile device 32 is entered into the server computer system 22 during the log-in process of Step 208 or during the sign-in preceding Step 202. Each phone number is also associated with a respective carrier at the server computer system 22. The server computer system 22 can thus associate a respective carrier with the user mobile device 32. Each respective carrier is also tagged with its ability to transmit full-track content.

If, at Step 214, the server computer system 22 determines that the respective carrier does not support transmission of full-track content, then Step 216 is carried out. At Step 216, full-track content is made available for personal computer (PC) download only.

If, at Step 214, the server computer system 22 determines that the respective carrier does support transmission of full-track content, then Step 218 is carried out. At Step 218, a user at the user computer system 24 enters the type and make of the user mobile device 32, and whether a data plan is associated with the user mobile device 32. Following Step 218, the server computer system 22 determines whether the respective mobile device is supported for purposes of transmission of full-track content. A list of mobile device types is stored on the server computer system 22, and each mobile device type is tagged with its ability to received full-track content. The server computer system 22 can thus associate the ability to receive full-track content with the user mobile device 32 based on its type. If, at Step 220, the server computer system 22 determines that the user mobile device 32 does not support full-track content based on its type, Step 216 is carried out. If, at Step 220, the server computer system 22 determines that full-track content is supported, Step 222 is carried out.

At Step 222, the server computer system 22 determines whether a data plan is entered at Step 218 which supports transmission of full-track content. If, at Step 222, the server computer system 22 determines that full-track content is supported, the server computer system 22 carries out Step 224. Whether or not the user mobile device 32 can support full-track content is determined at steps 214, 220, and 222.

At Step 224, the server computer system 22 transmits an SMS message over the SMS/MMS network 40 to the user mobile device 32. The SMS message includes a link to the respective full-track content media file on the file server 42. The user of the user mobile device 32 can select the link to download the full-track content media file from the file server 42. The full-track content media file corresponds with an entry in the file database 44 and shown in the search results 178 of FIG. 3.

If, at Step 222, the server computer system 22 determines that a data plan is not entered at Step 218, Step 226 is carried out. At Step 226, the user at the user computer system 24 is given the option to send the full-track content media file to the user mobile device 32, regardless of the fact that there is no data plan. At Step 228, the server computer system 22 determines whether the user has selected to transmit the full-track content media file anyway. If the server computer system 22 determines that the user has not elected to transmit the full-track media content file anyway, Step 216 is carried out. If the server computer system 22 does determine that the user has elected to send the full-track content media file anyway, Step 224 is carried out as hereinbefore described.

The server computer system 22 carries out Step 230 following Steps 206, 212, 216, or 224. At Step 230, a user-specific page corresponding to the user computer system 24 is updated with a link to the full-track media content downloaded at Steps 216 or 224, or a link to a ringtone that is transmitted and downloaded at Steps 206 or 212.

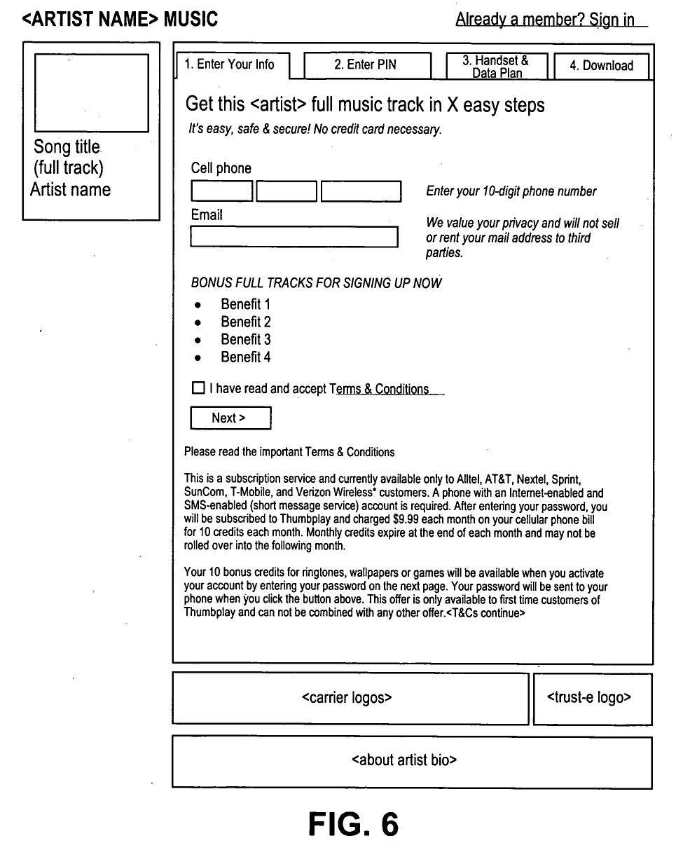

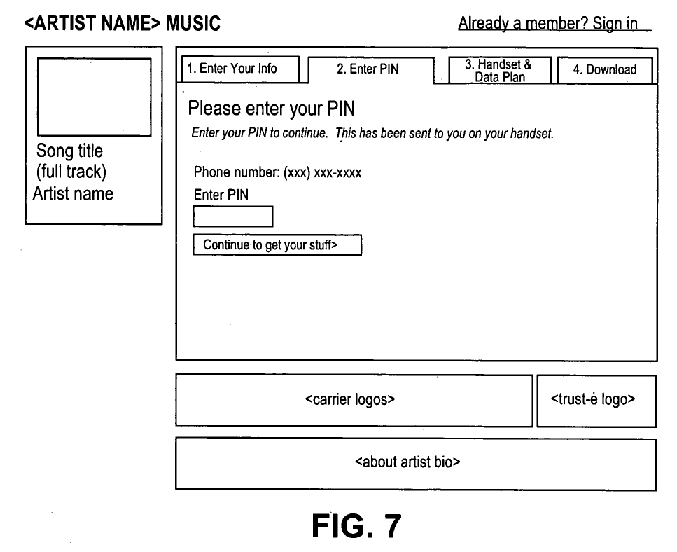

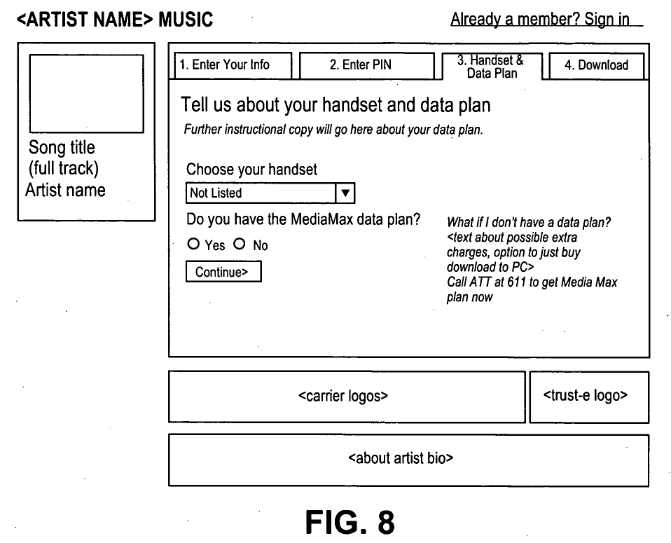

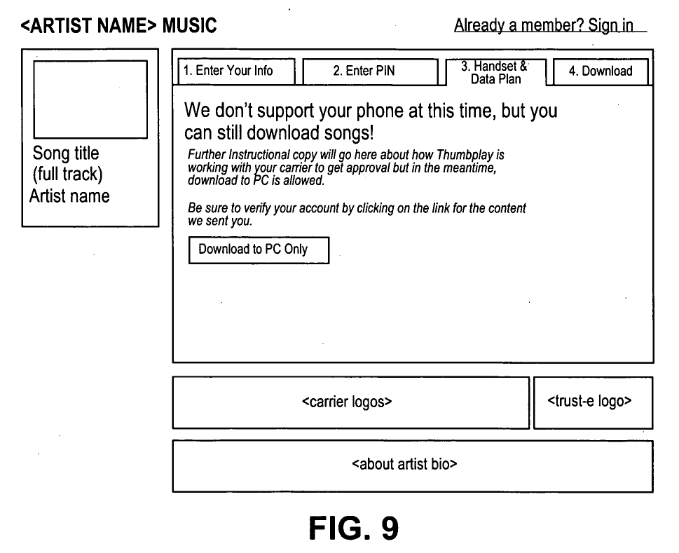

FIGS. 6 to 10 are views that are displayed at the user computer system 24 in FIG. 1, in the event that the user computer system 24 is not signed in at Step 202 in FIG. 5. FIGS. 6 and 7 are views that include fields for entering a mobile phone number, an e-mail address, and a PIN number, as part of a log-in process in Step 208 of FIG. 5. FIG. 8 is a view that is displayed at Step 218 in FIG. 5, with fields for entering a type of a mobile device and whether a data plan is associated with the mobile device. FIG. 9 is a view that is displayed if, following Step 220 in FIG. 5, the server computer system 22 determines that the type of mobile device is not supported. The view also includes a button that can be selected to download the full-track media content file directly onto the user computer system 24.

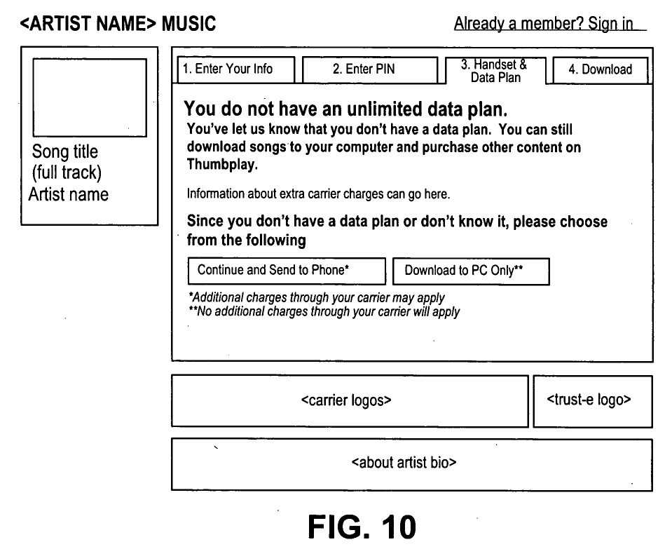

FIG. 10 is a view that is displayed if, following Step 222 in FIG. 5, the server computer system 22 determines that there is not an unlimited data plan associated with the user mobile device 32, due to the selection made by the user in FIG. 8. FIG. 10 includes two buttons that can be selected. Should the user select the button entitled “Continued Sent to Phone,” the server computer system 22 will execute Step 224 in FIG. 5. Should the user select the button entitled “Download to PC Only,” then the server computer system 22 will not execute Step 224 in FIG. 5, but instead execute Step 216 in FIG. 5.

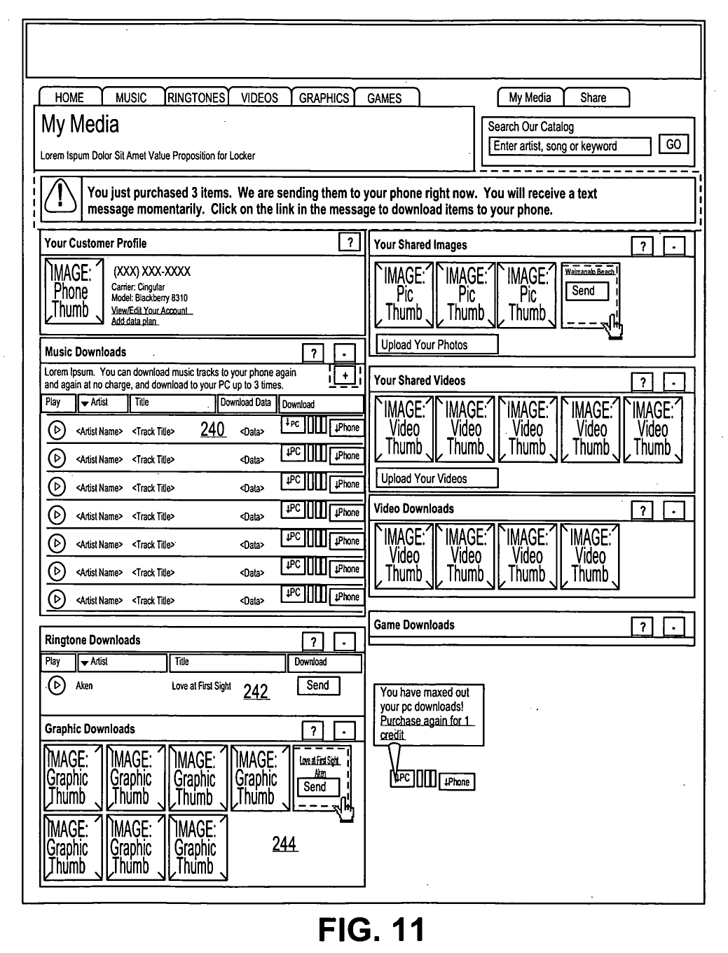

FIG. 11 shows a view that is displayed at Step 230 in FIG. 5. The view of FIG. 11 includes links to files on the file server 42 in FIG. 1, including an area 240 for links to full-track content media files, an area 242 for links to reduced media content files or ringtones, and an area 244 with links to graphic files on the file server 42. The links correspond to files that have previously been purchased and downloaded at Steps 206, 212, 216, or 224 in FIG. 5. The links in the areas 240, 242, and 244 can all be sent to the user mobile device 32 in FIG. 1. The links in the areas 240 and 244, for example, have respective buttons that can be selected to instruct the server computer system 22 to send the respective associated files to the user mobile device 32. A cursor can be used to mouse over the links in the area 244, which displays a button to send the respective associated graphic to the user mobile device 32.

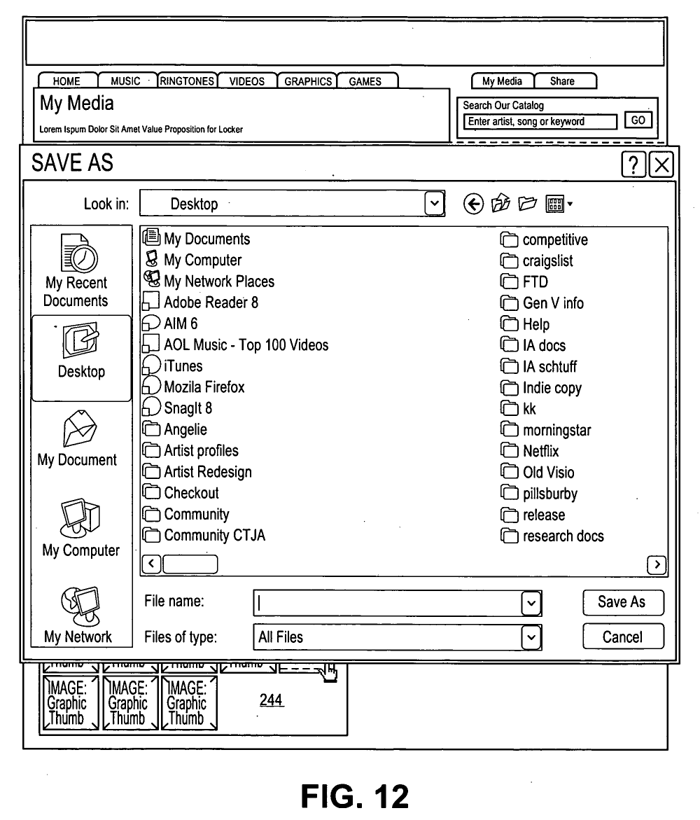

In addition, the links in the area 240 also have an associated button that can be selected to download the associated full-track content media file from the file server 42 in FIG. 1 directly onto the user computer system 24. FIG. 12 is a view that is displayed upon selection of one of the buttons that permit downloading onto the user computer system 24. The view in FIG. 12 is the same as the view in FIG. 1, except that it includes a window displaying a file structure that can be browsed to select the location for downloading the full-track media content file. The window also includes a field for entering a file name and buttons to either save the full-track content media file or to cancel. Should the button be selected to save the full-track content media file, the full-track content media file is downloaded from the file server 42 onto the user computer system 24, and is saved in the hard drive of the user computer system 24.

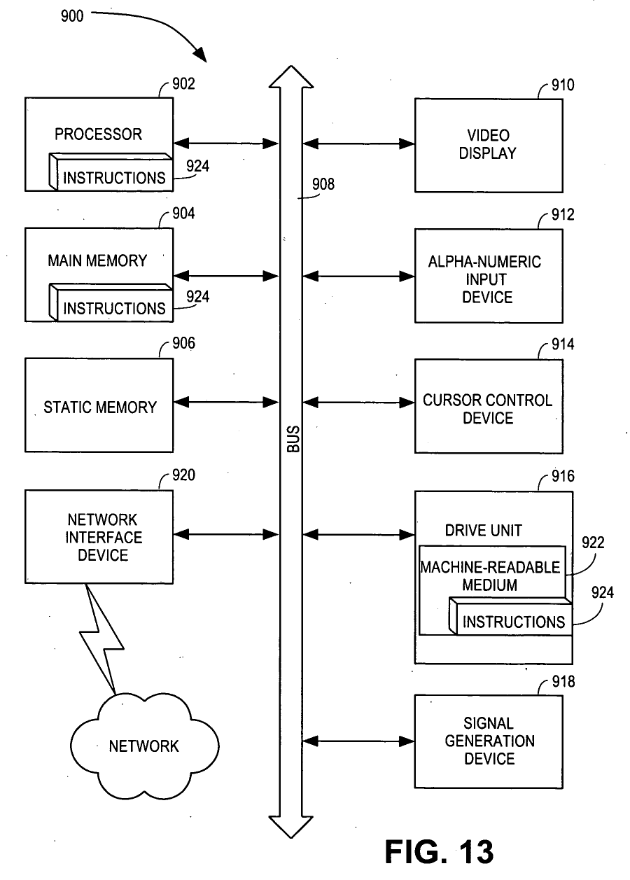

FIG. 13 shows a diagrammatic representation of a machine in the exemplary form of a computer system 900 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processor 902 (e.g., a central processing unit (CPU), a graphics processing unit (GPU) or both), a main memory 904 (e.g., read only memory (ROM), flash memory, dynamic random access memory (DRAM) such as synchronous DRAM (SDRAM) or Rambus DRAM (RDRAM), etc.), and a static memory 906 (e.g., flash memory, static random access memory (SRAM), etc.), which communicate with each other via a bus 908.

The computer system 900 may further include a video display 910 (e.g., a liquid crystal display (LCD) or a cathode ray tube (CRT)). The computer system 900 also includes an alpha-numeric input device 912 (e.g., a keyboard), a cursor control device 914 (e.g., a mouse), a disk drive unit 916, a signal generation device 918 (e.g., a speaker), and a network interface device 920.

The disk drive unit 916 includes a machine-readable medium 922 on which is stored one or more sets of instructions 924 (e.g., software) embodying any one or more of the methodologies or functions described herein. The software may also reside, completely or at least partially, within the main memory 904 and/or within the processor 902 during execution thereof by the computer system 900, the main memory 904 and the processor 902 also constituting machine-readable media.

The software may further be transmitted or received over a network 928 via the network interface device 920.

While the machine-readable medium 924 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A method of transferring media, comprising:
receiving a selection from a user computer system over a network at a server computer system;
transmitting a download page from the server computer system to the user computer system, the download page having a link, based on the selection, a full-track content media file being downloadable from the server computer system onto the user computer system when selecting the link;
determining at the server computer system whether a mobile device can receive full-track content; and
transmitting the full-track content media file from the server computer system to the mobile device in response to the selection, only if the mobile device can receive full-track content.

2. The method of claim 1, further comprising:
determining at the server computer system whether a carrier of the mobile device supports full-track content, as part of a process to determine whether the mobile device can receive full-track content.

3. The method of claim 2, further comprising:
determining at the server computer system whether a type of the mobile device supports full-track content, as part of a process to determine whether the mobile device can receive full-track content.

4. The method of claim 1, further comprising:
determining at the server computer system whether a data plan is associated with the mobile device, as part of the process to determine whether the mobile device can receive full-track content.

5. The method of claim 4, transmitting a data plan override page from the server computer system to the user computer system if a data plan is not associated with the mobile device;
receiving a data plan override selection from the user computer system after a user makes a selection on the data plan override page; and
transmitting the full-track content media file from the server computer system to the user computer system, only if the data plan override selection indicates that the full-track content media file should be transmitted and not when the data plan override selection indicates that the full-track content media file should not be transmitted.

6. A method of transferring media, comprising:
transmitting an options page from a server computer system to a user computer system, the options page including a full-track link and a reduced-track link, selection of the reduced-track link facilitating transmission of a reduced media file corresponding to a time portion only of a full-track content media file, from the server computer system to a user mobile device;
receiving a selection from the user computer system after the user selects the full-track link;
determining at the server computer system whether a mobile device can receive full-track content; and
transmitting the full-track content media file from the server computer system to the mobile device in response to the selection, only if the mobile device can receive full-track content.

7. A computer-readable medium having stored thereon a set of instructions which, when executed by a processor of at least one computer system, executes a method of transferring media, comprising:
receiving a selection from a user computer system over a network at a server computer system;
transmitting a download page from the server computer system to the user computer system, the download page having a link, based on the selection, a full-track content media file being downloadable from the server computer system onto the user computer system when selecting the link;
determining at the server computer system whether a mobile device can receive full-track content; and
transmitting the full-track content media file from the server computer system to the mobile device in response to the selection, only if the mobile device can receive full-track content.

8. A computer-readable medium having stored thereon a set of instructions which, when executed by a processor of at least one computer system, executes a method of transferring media, comprising:
transmitting an options page from a server computer system to a user computer system, the options page including a full-track link and a reduced-track link, selection of the reduced-track link facilitating transmission of a reduced media file corresponding to a time portion only of a full-track content media file from the server computer system to a user mobile device;
receiving a selection from the user computer system after the user selects the full-track link;
determining at the server computer system whether a mobile device can receive full-track content; and
transmitting the full-track content media file from the server computer system to the mobile device in response to the selection, only if the mobile device can receive full-track content.

9. A server computer system, comprising:
a file server;
a database, having entries corresponding to files in the file server;
a memory, holding a set of instructions; and
a processor that executes the instructions, the instructions comprising:
receiving a selection from a user computer system over a network at a server computer system;
transmitting a download page from the server computer system to the user computer system, the download page having a link, based on the selection, a full-track content media file being downloadable from the server computer system onto the user computer system when selecting the link;
determining at the server computer system whether a mobile device can receive full-track content; and
transmitting the full-track content media file from the server computer system to the mobile device in response to the selection, only if the mobile device can receive full-track content.

10. A server computer system, comprising:
a file server;
a database, having entries corresponding to files in the file server;
a memory, holding a set of instructions; and
a processor that executes the instructions, the instructions comprising:
transmitting an options page from a server computer system to a user computer system, the options page including a full-track link and a reduced-track link, selection of the reduced-track link facilitating transmission of a reduced media file corresponding to a time portion only of a full-track content media file from the server computer system to a user mobile device;
receiving a selection from the user computer system after the user selects the full-track link;
determining at the server computer system whether a mobile device can receive full-track content; and
transmitting the full-track content media file from the server computer system to the mobile device in response to the selection, only if the mobile device can receive full-track content.
